(19) United States
(12) Patent Application Publication
(10) Pub. No.: US 2022/0324148 A1
(43) Pub. Date: Oct. 13, 2022

(54) CONTROLLER FOR INJECTION MOLDING MACHINE INCLUDING SCREEN DISPLAY DEVICE, AND INJECTION MOLDING MACHINE

(71) Applicant: THE JAPAN STEEL WORKS, LTD., Tokyo (JP)

(72) Inventor: Shogo KOSUE, Tokyo (JP)

(21) Appl. No.: 17/715,226

(22) Filed: Apr. 7, 2022

(30) Foreign Application Priority Data
Apr. 13, 2021 (JP) 2021-067476

(51) Int. Cl. B29C 45/76; B29C 45/17; G05B 15/02

(52) U.S. Cl. CPC B29C 45/76; B29C 45/1774; G05B 15/02; B29C 2045/7606

(57) ABSTRACT

A controller for an injection molding machine includes a display device displaying various screens of the injection molding machine and configured to receive a screen operation by a user through an operation interface. The controller is configured to, in a case where it is determined that a display character siring exceeding a display width in a standard font size is to be displayed in a character string display field provided on the various screens, cause the display device to display the entire display character string in a font with a reduced horizontal width ratio in a state where a vertical width ratio of the font is maintained.

### CROSS-REFERENCE TO RELATED APPLICATIONS

This application is based on and claims priority under 35 USC 119 from Japanese Patent Application No. 2021-067476 filed on Apr. 13, 2021, the contents of which are incorporated herein by reference.

### TECHNICAL FIELD

The present invention relates to a controller provided in an injection molding machine and including a display device on which various screens are displayed, and an injection molding machine including such a controller.

### BACKGROUND

An injection molding machine is provided with a controller that controls each of devices constituting the injection molding machine. A display device is provided in the controller, and displays a setting screen on which setting, value data necessary for controlling each of the devices is displayed and set, an operation screen through which the injection molding machine is operated and on which measurement value data measured by each sensor is displayed, and the like. The screen displays a character string describing contents of the screen and a character string describing contents of various kinds of data to be displayed. For example, a character string “injection speed” is displayed for data indicating a speed of a screw driven in an injection process.

Many injection molding machines exported to various countries are compatible with many languages, and when a display language is switched, the character strings displayed on each of the screens are switched to each of the languages,.However, a display width of an object for displaying the character string, that is, a character string display field, allocated to the screen is fixed according to a design of the screen. Then, when the language is switched, the character string may not be appropriately displayed.

PTL 1 (JP-A-2017-24381) proposes a method of displaying a character string of a language in a character string display field even when the language is switched. Specifically, when the character string to be displayed exceeds a display width of the character string display field, the character string to be displayed is displayed in the character string display field by reducing a vertical width and a horizontal width, that is, bye reducing a font size.

### SUMMARY

In the method described in PTL 1, the entire character string can be displayed in the character string, display field, but there is a problem that it is difficult to read if the font size is too small.

The present disclosure provides a controller for an injection molding machine that includes a display device that displays a screen and displays a character string in a character string display field of the screen in an easily readable manner, and an injection molding machine.

Other problems and novel features will become apparent from the description of this specification and the accompanying drawings.

A controller for an infection molding machine includes a display device that displays various screens. In a case of displaying various screens, the controller is configured to, in a case where it is determined that a display character string to be displayed in a character string display field provided on the screen exceeds a display width in a standard font size, cause the display device to display the various screens in a font with only a horizontal width ratio of the font reduced and a vertical width ratio thereof maintained.

The present disclosure has an advantage of displaying a display character string on a screen in an easily readable manner.

### BRIEF DESCRIPTION OF DRAWINGS

FIG. 1 is a front view showing an injection molding machine according to the present illustrative embodiment;

FIG. 2 is a diagram showing a part of a Japanese display setting screen displayed on a display device by a controller according to the present illustrative embodiment;

FIG. 3 is a table showing a character string management database according to the present illustrative embodiment;

FIG. 4 is a flowchart of processing on a display character string of screen display performed in the controller according to the present illustrative embodiment;

FIG. 5 is a flowchart of processing on a display character string of screen display performed in the controller according to the present illustrative embodiment;

FIG. 6 is a diagram illustrating an example of processing on the display character string according to the present illustrative embodiment;

FIG. 7 is a diagram showing a part of an English display setting screen displayed on the display device by the controller according to the present illustrative embodiment;

FIG. 8 is a diagram showing a part of an English display setting screen displayed on the display device by the controller according to the present illustrative embodiment;

FIG. 9 is a diagram show Mg a part of an English display setting screen displayed on the display device by the controller according to the present illustrative embodiment; and

FIG. 10 is a diagram showing a sub-window of the English display setting screen displayed on the display device by the controller according to the present illustrative embodiment.

### DETAILED DESCRIPTION

Hereinafter, illustrative embodiments will be described in detail with reference to the drawings. However, the present invention is not limited to the following illustrative embodiments. In order to clarify the description, the following description and the drawings are simplified as appropriate. In the drawings, the same elements are denoted by the same reference numerals, and repeated description thereof is omitted as necessary. In addition, hatching may be omitted to avoid complicating the drawings.

The present illustrative embodiment will be described.

{Injection Molding Machine}

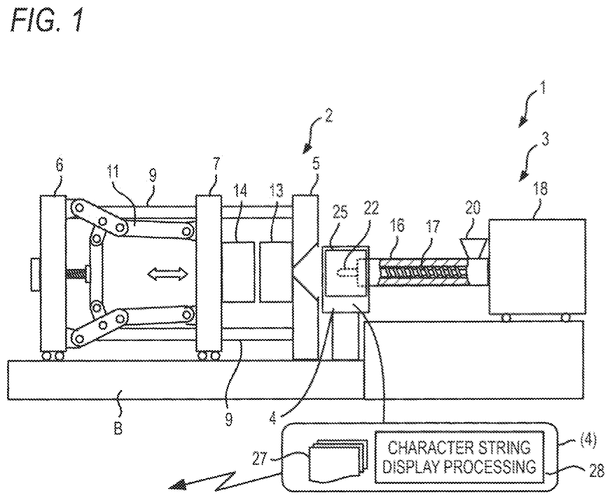

As shown in FIG. 1, an injection molding machine 1 according to the present illustrative embodiment schematically includes a mold clamping device 2 that clamps a mold, an injection device 3 that melts and injects an injection material, and a controller 4 according to the present illustrative embodiment that controls the mold clamping device 2 and the injection device 3.

{Mold Clamping Device}

The mold champing device 2 includes a fixed platen 5 fixed on a bed B, a mold clamping housing 6 that slides on the bed B, and a movable platen 7 that slides on the bed Bin the same manner. The fixed platen 5 and the mold clamping housing 6 are connected by a plurality of, for example, tour tie bars 9. The movable platen 7 is slidable between the fixed platen 5 and the mold clamping housing 6. A mold clamping mechanism 11 is provided between the mold clamping housing 6 and the movable platen 7. The mold clamping mechanism 11 may include a direct pressure type mold clamping mechanism, that is, a mold clamping cylinder, and in the present illustrative embodiment, the mold clamping mechanism 11 includes a toggle mechanism. The fixed platen 5 and the movable platen 7 are respectively provided with molds 13 and 14, and when the mold clamping mechanism 11 is driven, the molds 1 and 14 are opened and closed.

{Injection Device}

The injection device 3 includes a heating cylinder 16, a screw 17 housed in the heating cylinder 16, and a screw drive device 18 that drives the screw 17. A hopper 20 is provided in the vicinity of a rear end portion of the heating cylinder 16, and an injection nozzle 22 is provided at a front end of the heating cylinder 16.

{Controller}

As shown in FIG. 1, the controller 4 according to the present illustrative embodiment is provided on the bed B, and includes a display device 25. Various control programs are stored in the controller 4, and the controller 4 controls the mold clamping device 2, the injection device 3, and the like as described above. The controller 4 also stores screen programs corresponding to various screens to be displayed on the display device 25. The various screens include a setting screen on which setting data for the control programs are displayed and set, an operation screen through which the injection molding machine 1 is operated and on which measurement value data measured by each sensor is displayed, and the like. The display device 25 includes an operation interface (one example of operation means) for a user to operate the screen. Specifically, in the present illustrative embodiment, the display device 25 includes a touch panel as the operation interface. The display device 25 may include a keyboard, a mouse, and the like capable of inputting data as the operation interface,

The controller 4 according to the present illustrative embodiment is a so-called multilingual controller, and a language to be displayed on the screen can be selected. As will be described in detail later, a character string to be displayed is selected based on the selected language on the various screens displayed on the display device 25. The controller 4 according to the present illustrative embodiment has a function of appropriately adjusting a length of the selected character string such that the selected character string can be easily seen even when the length of the selected character string is larger than a display width of the character string display field allocated to the screen. In order to implement this, the controller 4 is provided with a character string management database 27 which will be described later.

{Setting: Screen Based on Japanese Display}

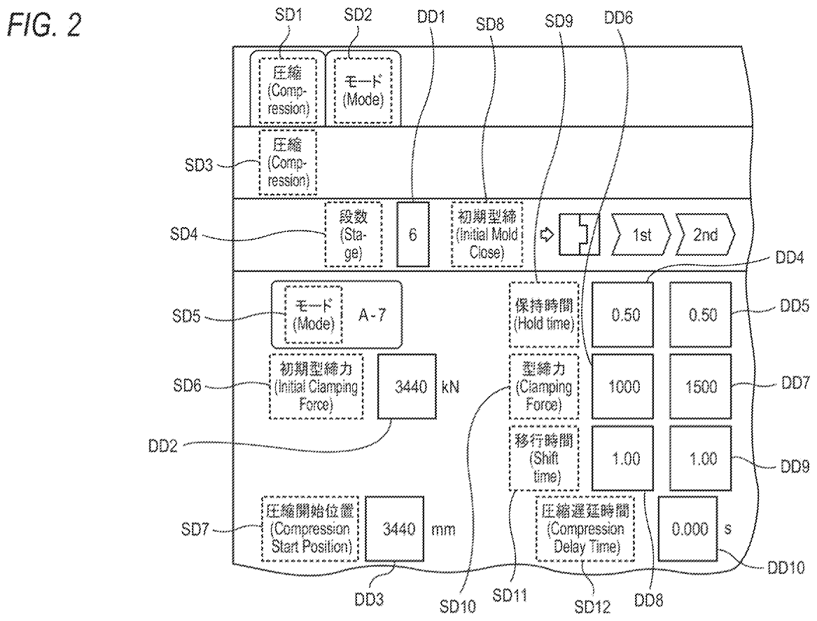

FIG. 2 shows a part of a screen displayed when Japanese is selected as the display language. More specifically, a pan of a setting screen on which various kinds of setting data necessary for performing a so-called injection compression process are set is shown. On the screen, a plurality of objects for displaying character strings, that is, character string, display fields SD1, SD2, and so on are allocated, and a plurality of objects for displaying data, that is, data display fields DD1, DD2, and so on are allocated.

A character string ID is allocated in advance as an attribute to each of the objects in the character string display fields SD1, SD2, and so on. The character string ID is an ID for specifying the character string to be displayed. For example, the same character string ID is allocated to the character string display fields SD1 and SD3, and the corresponding character string “ [symbol] (Compression)” is displayed. Further, different character string IDs are allocated to the character string display fields SD6 and SD7, respectively, and corresponding character strings “ [symbol] (initial clamping force)” and “ [symbol] (compression start position)” are displayed. A correspondence between the character string IDs and the character strings to be displayed is defined in the character string management database 27 (see FIG. 1) to be described below.

{Character String Management Database}

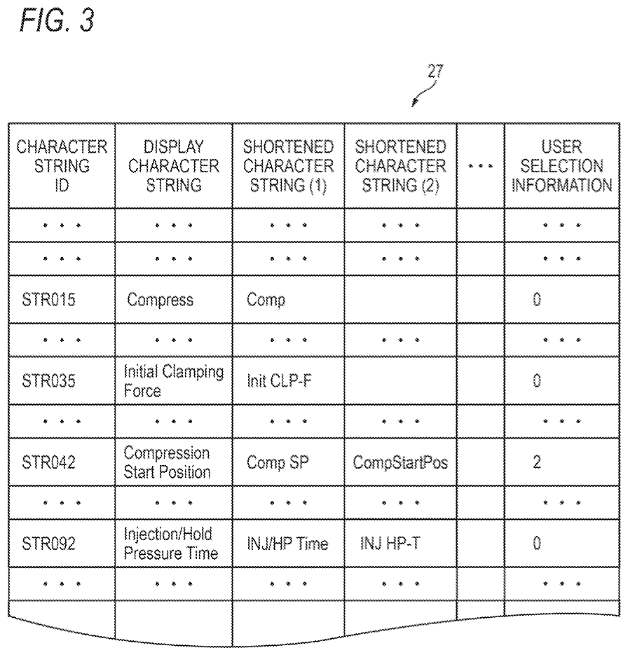

A plurality of character string management databases 27 according to the present illustrative embodiment are prepared for each language. In the present illustrative embodiment, the character string management databases 27 are prepared for each of Japanese, English, German, French, and Chinese, and the English character string management database 27 is shown in FIG. 3.

The character string management database 27 manages the following information.
Character String ID

Character string ID is an ID for associating with the character string, and is associated with the following display character string and shortened character string.
Display Character String

Display character string is a character string preferentially displayed in the character string display fields SD2, and so on, and is a character string including a format expression that is not shortened.
Shortened Character String

Shortened character string is a character string displayed when the display character strings in the character string display fields SD1, SD2, and so on cannot be displayed and including a shortened expression. In the present illustrative embodiment, a plurality of shortened character strings can be allocated to the character string ID.
User Selection Information

When there are the plurality of shortened character strings, the user can select and display the shortened character strings to be displayed in the character string display fields SD1, SD2, and so on. The user selection information is information for specifying the shortened character string selected last time.

{Character String Display Processing}

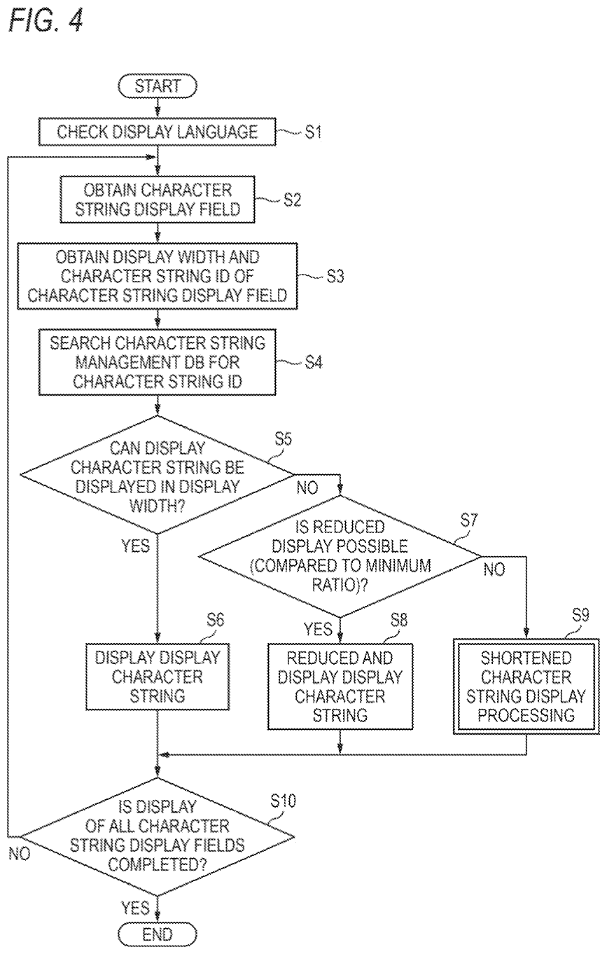

Character string display processing 28 performed in the screen display by the controller 4 according, to the present illustrative embodiment shown in FIG. 1 will be described. By a user operation, for example, the screen shown in FIG. 2 is called. Then, in the controller 4, the character string display processing 28 is performed together with the screen program. Hereinafter a flow of the character string display processing 28 will be described with reference to FIG. 4.

First, the display language is checked (step S1). When English is selected in the controller 4, the processing is performed based on the English character string management database 27 shown in FIG. 3,

Next, the character string display field allocated to the screen is searched for, and the character string display field is obtained (step S2). That is, the character string display fields SD1, SD2, and so on (see FIG. 2) allocated to the screen are searched for, a character string display field SDx found first is obtained, and the subsequent processing is performed. Next, the display width and the character string ID defined as the attribute of the character string display field are obtained (step S3). Next, the character string management database 27 shown in FIG. 3 is searched for the character string ID as a key, and the corresponding display character string is obtained (step S4). When the shortened character string is also defined in the character string ID, the shortened character stripe and the user selection information are obtained in step S4.

Subsequently, it is checked whether the display character string can be displayed in the character string display field, that is, whether the display character string fits within the display width in the standard font size (step S5). When it is determined in step S5 that the display character string can be displayed (YES) the character string display processing 28 displays the display character string in the character string display field SD6 (step S6). When it is determined in step S5 that the character string cannot be displayed (NO), the character string display processing 28 checks whether the display character string can be displayed in the character string display field with the horizontal width ratio of the display character string reducing in a state where the vertical width ratio of the font is maintained (step S7). Whether the display is possible is determined in step S7 is determined by a minimum ratio defined in advance. For example, assuming that the minimum ratio is 50%, when the display character string cannot be displayed in the character string display field unless the display character string is reduced to the horizontal width ratio of 50% or less, it is determined in step S7 that the display character string cannot be displayed.

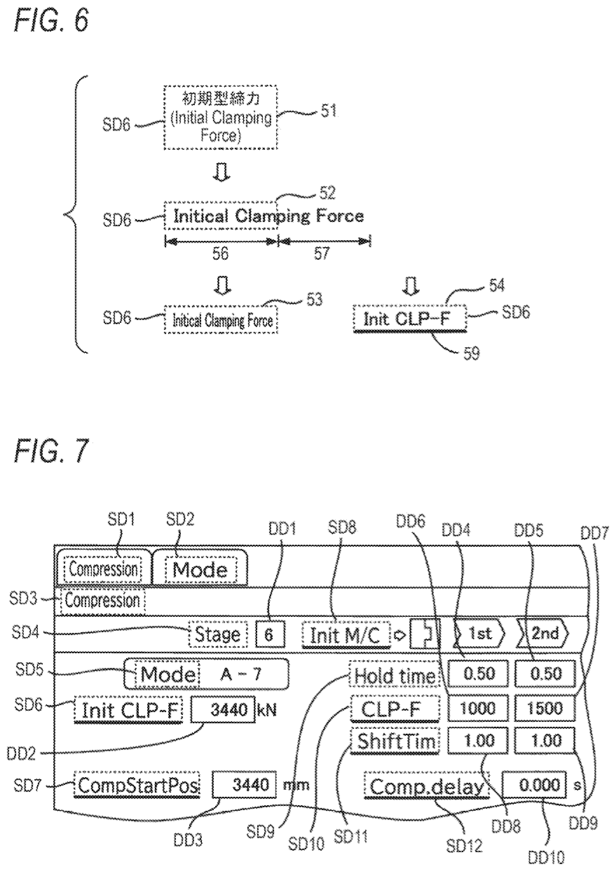

When it is determined in step S7 that the display character string can be displayed (YES), the display character string is reduced and displayed (step S8). That is, the horizontal width ratio is reduced and the display character string is displayed in the character string display field as indicated by a reference numeral 53 in FIG. 6. When it is determined in step S7 that the display character string cannot be displayed (NO), the process proceeds to shortened character string display processing that is sub-processing of the character string display processing 28 (step S9).

Following step S6, step S8, and step S9, it is determined whether the display of all the character string display fields is completed (step S10), in step S10, when the display of all the character string display fields is completed (YES), the processing is ended, and when the display of all the character string display fields is not completed (NO), the processing returns to step 52.

Here, the character string display processing 28 will be described with a specific example. In step S2, it is assumed that the character string display field SD6 (see FIG. 2) is first found. The character string display field SD6 is a display field in which “ [symbol] (initial clamping force)” is displayed when Japanese is selected as the display language as shown in FIG. 2 or as shown by a reference numeral 51 in FIG. 6.

When the character string ID allocated to the character string display field SD6 is “STR035”, “STR035” is obtained in the step S3. Then, in step S4, for the character string ID “STR035”, “Initial Clamping Force” as the display character string, “Init CLP-F” as the shortened character string (1), and “0” as the user selection information are obtained from the character string management database 27 (see FIG. 3).

It is checked in step S5 whether the display character string “Initial Clamping Force” in the character siring display field 506 fits within the display width in the standard font size. However, actually, as indicated by a reference numeral 52 in FIG. 6, the displayed character string “Initial Clamping Force” cannot be displayed in the character string display field SD6. This is because the display field indicated by a reference numeral 56 is exceeded by a reference numeral 57. Therefore, the character string display processing 28 proceeds from step S5 to step S7.

In step S7, as shown in FIG. 6, it is checked in the character string display field SD6 whether the display character string “Initial Clamping Force” can be displayed in the character string display field SD6 with the horizontal width ratio reduced in the state where the vertical width ratio of the font is maintained. Since the character string “Initial Clamping Force” cannot be displayed in the character string display field SD6 even when the character string Initial Clamping Force” is reduced at the minimum ratio, the process proceeds from step S7 to step S9 (shortened character string display processing that is the sub-processing of the character string display processing 28). Then, when the shortened character string display processing is completed, it is checked whether the character string display field SDx in which the display of the character string is not completed remains on the screen. When the character string display field SDx remains, the processing is repeated from step S2. When the display of the character strings in all the character string display fields SDx is completed, the processing ends.

{Shortened Character String Display Processing}

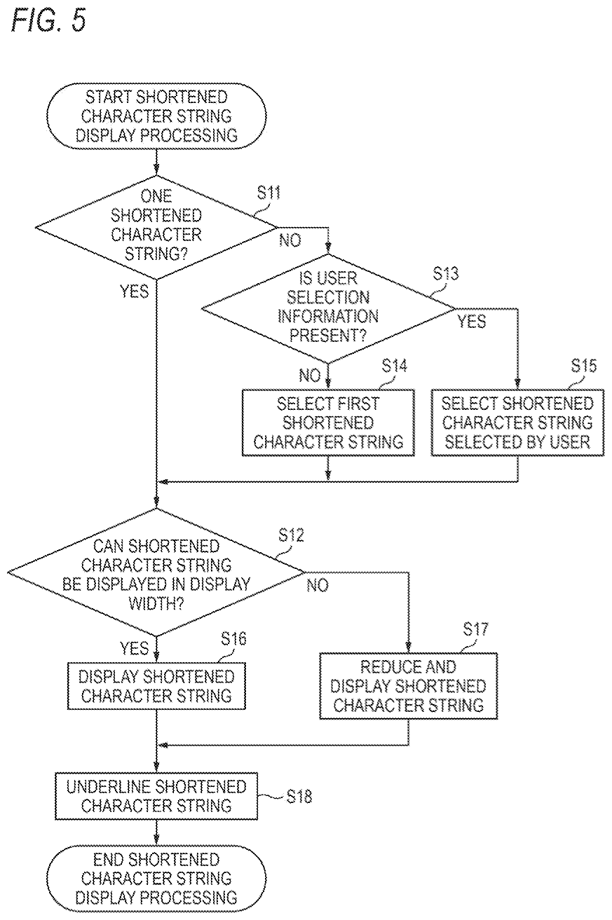

Hereinafter, a flow of the shortened character string display processing that is the sub-processing of the processing of step S9 in FIG. 4 will be described with reference to FIG. 5. First, it is checked whether there is one shortened character string or a plurality of shortened character strings registered for the character string ID (step S11).

In step S11, when there are a plurality of shortened character strings (NO), it is checked whether the user selection information is registered (step S13). In step S13, when the user selection information is not registered (NO), a first shortened character string is selected (step S14), and the processing proceeds to step S12 to be described later. In step S13, when the user selection information is registered (YES), the shortened character string selected by the user is selected (step S15), and the processing proceeds to step S12 to be described later. As will be described later, when there are the plurality of shortened character strings, the user can select the shortened character string to be displayed.

When it is determined in step S11 that there is one shortened character string (YES), it is determined Whether the shortened character string can be displayed in the display width (step S12). That is, it is checked whether the shortened character string exceeds the display width in the standard font size, in step S12, when the shortened character string can be displayed in the display width (YES), the shortened character string is displayed (step S16), In step S12, when the shortened character string cannot be displayed in the display width (NO). the shortened character string is reduced and displayed (step S16). Following step S16 and step S17, the shortened character suing is underlined as a character decoration (step S18), and the shortened character string display processing is ended.

Here, the shortened character string display processing will be described with a specific example. As shown in FIG. 3, since only one shortened character string is registered for the character string ID “STR035”, the processing may proceed to step S12. When two or more shortened character strings are registered, the processing proceeds from step S11 to step S13. For example, a case of the character string ID “STR042”, “STR292”, or the like corresponds to this. This is because, as shown in FIG. 3, two shortened character strings are registered for these character string IDs. In such a case, the processing proceeds to step

In step S13, when the user selection information is a numerical value “0” in the character string management database 27 shown in FIG. 3, it is determined that there is no user selection information, the processing proceeds to step S14, the first shortened character string (1) is selected as the shortened character string to be displayed, and the processing proceeds to step S12.

On the other hand, in step S13, when the user selection information is numerical value other than “0” in the character string management database 27 shown in FIG. 3, the processing proceeds to step S15. The numerical value registered as the user selection information is a number of the shortened character string previously selected by the user. For example, for the character string ID “STR042”, the user selection information is “2” as shown in FIG. 3. This indicates that the shortened character string (2) “CompStartPos” is previously selected by the user. In step S15, the shortened character string recorded by the user selection information, that is, the shortened character string (2) in this example, is selected, and the processing proceeds to step S12.

In step S12, it is checked whether the selected shortened character string can be displayed in the character string display field SD6. When the shortened character string does not exceed the display width, step S16 is performed to display the shortened character string in the character string display field SD6 as indicated by a reference numeral 54 in FIG. 6. On the other hand, when it is found in step S12 that the shortened character string exceeds the display width, step S17 is performed to display the shortened character string in the character string display field SD6 with the horizontal width ratio reduced in the state where the vertical width ratio is maintained.

When the shortened character string is displayed in the character string display field SD6, the character decoration is applied in step S18 in order to indicate that the character string is the shortened character string. For example, the shortened character string can be an italic. form or a bold form. In the present illustrative embodiment, as indicated by a reference numeral 59 in FIG. 6, an underline is added to the shortened character string as the character decoration. The shortened character string display processing is ended.

FIG. 7 shows a part of a setting screen when English is selected as the display language. For example, in the character string display fields SD2, SD5, and SD9, the display character strings are displayed in the standard font site. In the character string display fields SD1, SD3, and SD4, the display character strings are displayed with the horizontal width ratio reduced. For the character string display fields SD6, SD7, SD8, SD10, SD11, and SD12, the shortened character strings are displayed, and the character decorations, that is, the underlines are added

{Other Functions of Character String Display Processing}

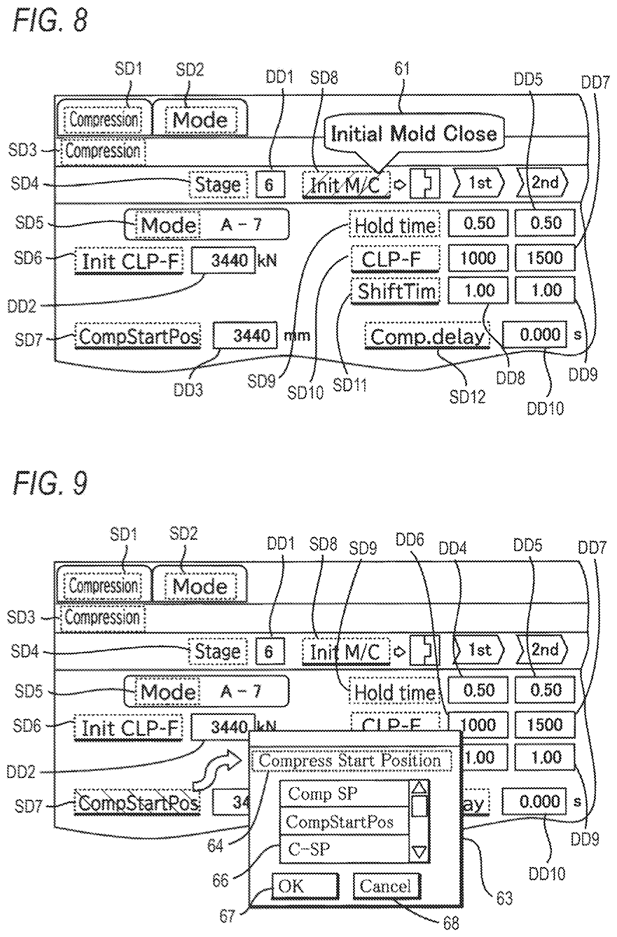

In the present illustrative embodiment, various functions are prepared for the character string display processing 28. As shown in FIG. 8, the character string display field SDx in which the shortened character string is displayed on the screen, tilt example, the character string display field SD8 is touched once. That is, the character string display field SD8 is selected. Then, a pop-up window 61 is displayed, and the display character string “Initial Mold Close” is displayed. That is, when the user cannot understand a content of the shortened character string displayed on the screen, when the character string display field SDx is selected, the display character string that is a formal expression can be displayed.

Further, when the plurality of shortened character strings are prepared, the user can select the desired shortened character string. As shown in FIG. 9, the character string display field SDx in which the shortened character string is displayed on the screen, for example, the character string display field 507 is touched twice. That is, the character stung display field SD7 is selected. Then, a shortened character string sub-window 63 is displayed.

In the shortened character string sub-window 63, a display character string field 64 in which the display character string is displayed, a list box 66 in which the plurality of shortened character strings are displayed in a list, an execution button 67, and a cancel button 68 are displayed. When the user presses the cancel button 68, the shortened character string sub-window 63 disappears. When the user selects the desired shortened character string and presses the execution button 67, the user selection information of the corresponding character string ID, for example, “STR042” is rewritten in the character string management database 27 shown in FIG. 3. Thereafter, when the screen is displayed, the shortened character string selected by the user is displayed. In other screens, the same shortened character string is displayed in the character string display field SDx to which the same character string ID is allocated.

{Other Illustrative Embodiments}

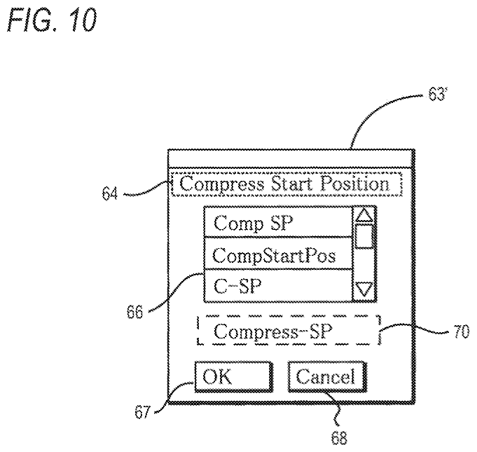

The character string display processing 28 in the controller 4 according to the present illustrative embodiment can be variously modified. For example, the shortened character string may be edited by the user, FIG. 10 shows a shortened character string sub-window 63′ according to another illustrative embodiment that is displayed when the character string display field SDx in which the shortened character string is displayed is touched twice. The shortened character string sub-window provided with a shortened character string editing text box 70. The shortened character string selected in the list box 66 is displayed in the shortened character string editing text box 70. Alternatively, when a blank is selected in the list box 66, the blank is displayed.

The user can freely edit the shortened character string in the shortened character string editing text box 70. When the execution button 67 is pressed, the shortened character string edited by the user is written in the character stringy, management database 27 shown in FIG. 3. At this time, the controller 4 in FIG. 1 may transmit the shortened character string edited by the user with the communication function to a manufacturer of the injection molding machine 1. The manufacturer is provided with a management computer. The transmitted shortened character string is input to the management computer. The manufacturer can know the shortened character string recommended by the user, and can refer to the shortened character string in future product development.

{Other Modifications}

Although the present illustrative embodiment describes that the plurality of shortened character strings can be registered for the character string. ID, the number of characters that can be registered may be only one. Further, the present illustrative embodiment describes that the user selection information is managed for the character string ID in the character string management database 27. However, the user selection information may be managed corresponding to the character string display field SDx on the screen. Then, it is possible to cope with a case where the user wants to select a specific shortened character string only in the character string display field SDx of a certain screen and to select another shortened character string on another screen. This is because the shortened character string to be displayed can be changed for each screen. Further, although the above-described illustrative embodiments have been explained for the case where the display language is switched from Japanese to English, the present invention can also be applied to various modifications (e.g., for a case where the display language is switched from Japanese to German, from Chinese to English, from English to German).

Although the invention made by the present inventor has been specifically described above based on the illustrative embodiment, it is needless to say that the present invention is not limited to the illustrative embodiment described above, and various modifications can be made without departing from the scope of the present invention. The plurality of examples described above can be implemented in combination as appropriate.

What is claimed is:

1. A controller for an injection molding machine, comprising:
a display device displaying various screens of the injection molding machine configured to receive a screen operation by a user through an operation interface,
wherein in a case where it is determined that a display character string exceeding a display width in a standard font size is to be displayed in a character string display field provided on the various screens, the controller is configured to cause the display device to display the entire display character string in a font with a reduced horizontal width ratio in a state where a vertical width ratio of the font is maintained.

2. The controller for an injection molding machine according to claim 1, wherein in a case where it is determined that the horizontal width ratio is smaller than a preset minimum ratio, the controller is configured to cause the display device to display a shortened character string consisting of a shortened expression prepared in advance corresponding to the displayed character string in the character String display field.

3. The controller for an injection molding machine according to claim 2, wherein in a case where it is determined that the shortened character string exceeds the display width in the standard font size when the shortened character string is to be displayed in the character string display field, the controller is configured to cause the display device to display the entire shortened character string in the font with the reduced horizontal width ratio in the state Where the vertical width ratio of the font is maintained.

4. The controller for an injection molding machine according to claim 2, wherein in a case where the shortened character string is to be displayed in the character string display field, the controller is configured to apply a character decoration to the shortened character string.

5. The controller for an injection molding machine according to claim 2, wherein in the case where the shortened character string is displayed in the character string display field, based on the character string display field being selected by the operation interface, the controller is configured to cause the display device to pop up a small window displaying the displayed character string.

5. The controller for an injection molding machine according to claim 2,
wherein a plurality of shortened character strings are prepared for the display character string, and
wherein based on the character string display field being selected from the operation interface, the controller is configured to:
cause the display device to display a list box in which the plurality of shortened character strings are displayed in a list; and
store the shortened character string selected from the operation interface in the list box, and
wherein in a case where the various screens are displayed thereafter, the controller is configured to cause the display device to display the selected shortened character string in the character string display field.

7. The controller for an injection molding machine according to claim 2, wherein the controller is provided with a database for managing the display character string and the shortened character string in association with each other, and the display character string or the shortened character string to be displayed in the character string display field of the various screens is referred to by the controller from the database.

8. The controller for an injection molding machine according to claim 7, wherein the database is editable by the user to allow editing of the shortened character suing associated with the display character string.

9. The controller for an injection molding machine according to claim 8,
wherein the controller includes a user custom registration screen for allowing the user to edit the shortened character string, and
wherein the controller is configured to output a warning in a case were it is determined that a number of characters of the shortened character string edited on the user custom registration screen exceeds a limit number of characters.

10. The controller for an injection molding machine according to claim 8, wherein the controller is provided with a communication function and is configured to transmit the shortened character string edited by the user in the database to an external management computer by using the communication function.

11. An injection molding machine comprising:
an injection device configured to an injection material;
a mold clamping device configured to clamp a mold; and
a controller configured to control the injection device and the mold clamping device, the controller comprising a display device configured to display various screens,
wherein in a case where it is determined that a display character string exceeding a display width in a standard font size is to be displayed in a character string display field provided on the various screens, the controller is configured to cause the display device to display the entire display character string in is font with a reduced horizontal width ratio in a state where a vertical width ratio of the font is maintained.

12. The injection molding machine according to claim 11, wherein in a case where it is determined that the horizontal width ratio is smaller than a preset minimum ratio, the controller is configured to cause the display device to display a shortened character string consisting of a shortened expression prepared in advance corresponding to the displayed character string is displayed in the character string display field.

13. The injection molding machine according to claim 12, wherein in a case where it is determined that the shortened character string exceeds the display width in the standard font size when the shortened character string, is to be displayed in the character string display field, the controller is configured to cause the display device to display the entire shortened character string in the font with the reduced horizontal width ratio in the state where the vertical width ratio of the font is maintained.
